(19) United States
(12) Patent Application Publication
(10) Pub. No.: US 2003/0172052 A1
(43) Pub. Date: Sep. 11, 2003

(54) Conceptual framework and assessment tool for designing a personalized electronic textbook and other online educational software

(76) Inventors: Thomas Crandell, Binghamton, NY (US); Corinne Crandell, Binghamton, NY (US)

Correspondence Address: BROWN & MICHAELS, PC, 400 M & T BANK BUILDING, 118 NORTH TIOGA ST, ITHACA, NY, 14850, US

(21) Appl. No.: 10/264,828

(22) Filed: Oct. 4, 2002

Related U.S. Application Data
(60) Provisional application No. 60/363,083, filed on Mar. 11, 2002.

(51) Int. Cl. G06F 7/00

(52) U.S. Cl. 707/1

(57) ABSTRACT

A personalized electronic work includes a plurality of features of a content of the electronic work. The features are mapped to a plurality of cognitive styles. One method of the present invention maps features of the content of the electronic work to a plurality of cognitive styles, assesses a cognitive style of a user, evaluates mapped content relative to the attributes of the cognitive style of the user, and provides feedback to the user based on his cognitive style.

### REFERENCE TO RELATED APPLICATIONS

This application claims an invention which was disclosed in Provisional Application No. 60/363,083, filed Mar. 11, 2002, entitled “CONCEPTUAL FRAMEWORK AND ASSESSMENT TOOL FOR DESIGNING A PERSONALIZED ELECTRONIC TEXTBOOK AND OTHER ONLINE EDUCATIONAL SOFTWARE”. The benefit under 35 USC §119(e) of the U.S. provisional application is hereby claimed, and the aforementioned application is hereby incorporated herein by reference.

### BACKGROUND OF THE INVENTION

1. Field of the Invention

The invention pertains to the field of electronic publishing and more particularly, the invention pertains to tools for designing a personalized electronic textbook and other online educational software.

2. Description of Related Art

The rapid rise in the use of the World Wide Web (WWW) in teaching and learning has brought hypermedia into prominence as a mode of accessing information. The term “hypermedia” includes both mode and media of information presentation. Hypermedia can facilitate relatively nonsequential patterns as well as the sequential patterns that are characteristic of print media, allowing a wide range of design options to producers of online learning materials.

One of the fastest growing markets for online educational hypermedia products is textbook publishing. However, publishers of online educational electronic products are experiencing difficulty as they attempt to make the transition from two-dimensional linear print materials to multi-dimensional, learner-centered electronic products. Success in designing online educational products depends more on the product's ease of use and ease of learning than on the quality of the content alone. Increasingly, in online learning environments in which students are expected to acquire and learn information through hypermedia, students' ability to structure and manage their own navigation will become a required skill. Most attempts at electronic publishing to date have produced highly complex hypertext or vacuous hypermedia that is difficult to maintain with little thought to improving students' ease of learning and ease of use. An instructional design framework based on models of human learning and user interface design is needed to help guide the development of learner-centered online educational products.

### SUMMARY OF THE INVENTION

The present invention is a customized, interactive learning system whereby learners are provided with the opportunity to acquire information and navigate through the subject matter according to their preferred learning strengths, or cognitive styles. The personalized electronic work includes a plurality of features of a content of the electronic work, wherein the features are mapped to a plurality of cognitive styles. One method of the present invention maps features of the content of the electronic book to a plurality of cognitive styles, assesses a cognitive style of a user, evaluates mapped content relative to the attributes of the cognitive style of the user, and provides feedback to the user based on his cognitive style.

### BRIEF DESCRIPTION OF THE DRAWINGS

FIG. 1 shows a conceptual model for a personalized electronic textbook and other online educational software.

FIG. 2 shows the different variables of a cognitive style map profile.

FIG. 3a shows a schematic diagram of an example of a learning style requirements form where the resource/task activity is a picture of the cognitive style requirements needed to use an instructional resource or to complete an educational task successfully.

FIG. 3b shows a table of the learning style requirements of the task shown in FIG. 3a.

FIG. 3c shows a more comprehensive schematic diagram of the learning style requirements of the task shown in FIG. 3a.

FIG. 4 shows an example of an organizational scheme for the Trends in the Research Literature on User-Interface Design Report.

FIG. 5 shows an example of a concept map for a module of an E-book.

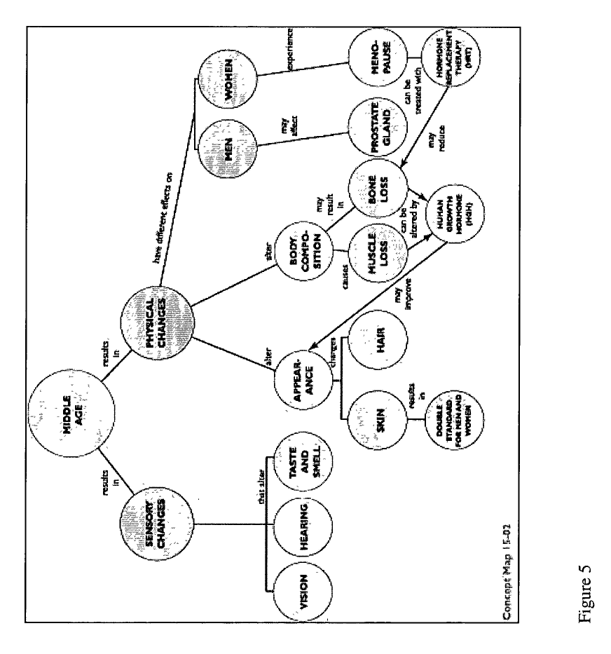

### DETAILED DESCRIPTION OF THE INVENTION

The terms “user”, “learner” and “student”, employed herein, are used interchangeably for the individual who is using the E-book to learn the material. The terms “cognitive style” and “learning style”, employed herein, will be defined further below, are used interchangeably to describe information processing preferences of learners or requirements of tasks. The terms “instructor”, “teacher”, and “professor”, employed herein, and are used interchangeably for someone who is teaching a course, and using the E-book as the textbook for that course.

The cognitive style approach is unique. Unlike other static learning style assessments that utilize a simplistic matching strategy, the present method for designing the instructional software exploits the dynamic relationship among individual differences in learning, the nature and features of the online learning task, and the content material to enhance learning outcomes. One of the critical differences between the present invention and other learning style tools is that the present invention uses both diagnostic and prescriptive components, while the prior art is primarily selection tools. A sophisticated software program, which is intuitive and easy to use, captures the dynamic features and learning characteristics of an online educational product. The cognitive style tool gives all learners the ability to exploit the online navigation tools and features of E-Books and other online educational products.

As more hypermedia products come online and distance education course offerings increase, students' ability to structure and manage their own navigation will become a required skill. Prior attempts at e-publishing have produced highly complex hypertext that is difficult to maintain with little thought to improving learning. The present invention provides a highly efficient method of creating manageable content for user-based online information that promotes ease of learning and ease of use.

Using the present invention to design online educational software, instructional media designers can draw cognitive profiles of potential users, derive cognitive attributes and strategies for developing learner-centered online textbooks, and provide new and innovative opportunities for content personalization in software-based online educational materials.

The Conceptual Model

The conceptual model of a software user interface is critical to the user interface's ease of learning and ease of use. When that model is unclear, does not match the user's expectations, or is absent entirely, it is a major hurdle for even the most consistent interface or talented programmer to overcome.

The conceptual model of a software product, especially an online electronic textbook (E-Book hereafter) is the means by which it communicates the software product's underlying operations and functionality to the user. It is the highest level of design, and through proper design strategies accommodates the user's ability to process and learn the content information. Educational software, especially online E-Books, should be designed to either match the user's existing thought processes (mental model) or should facilitate the development of an alternative mental model that ensures effective performance (i.e., comprehension and recall of facts and concepts in the instructional material). If the conceptual model closely coincides with the user's mental model, then the online product and its content information will be easier to use and learn.

Oftentimes, developers of online learning products do not understand the importance of designing a conceptual model prior to development of the software product. Instead they simply use a model that already exists—for example, the model of a printed book versus the model of an online book. This spells potential failure since success in conceptual design of online books is about communicating to the learner, rather than simply delivering content information.

Ease of Learning and Ease of Use

Educational software products should be designed for both ease of learning and ease of use. These terms are often overused or casually claimed, especially in the electronic publishing business. However, they are critical aspects of what instructional designers are trying to attain in any user-interface. These characteristics are often difficult to achieve in systems rich in functionality, especially simultaneously. Often, designs that attain one violate the other. This dilemma can be resolved, however, if the interface is designed with consideration of the cognitive style characteristics of the learner and complies with general principles of human learning.

Conceptual Framework

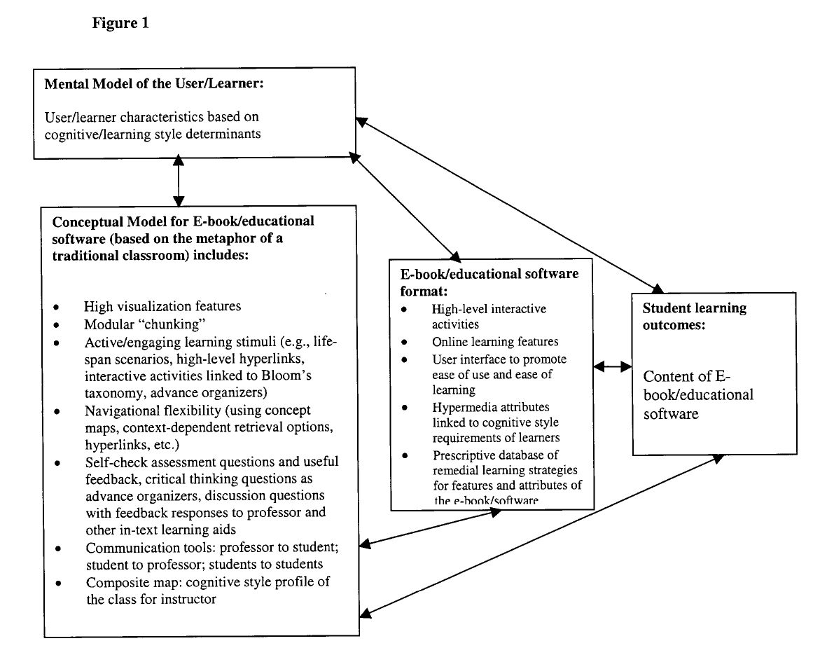

Referring to FIG. 1, the methodology for designing E-Books and other online educational software of the present invention is based on a conceptual framework including three interrelated components:

1. A mental model of the learner using a cognitive style paradigm.

2. Learner-centered design features for an E-Book and other online educational software.

3. A user-interface that considers the cognitive style characteristics of the target learner population and promotes ease-of-learning and ease-of-use.

Learning the content material of an E-book is facilitated by linking the information-processing preferences (cognitive style) of the user with the information-processing requirements of the learning tasks in the E-book. The receptivity (learnability) of the task is determined by the degree of match or mismatch between the cognitive style of the learner and the cognitive style requirements of the learning task.

Employing this framework, an instructional designer of an E-book assesses both the learner's cognitive style and the cognitive style attributes of the instructional task.

Extensive research findings derived from the fields of cognitive psychology, psychology of learning, human computer-interaction, and instructional design support the assumptions on which the present invention is based. These assumptions are:

1. All learning depends on the individual's currently activated field of knowledge (i.e., cognitive style of the learner).

2. Individuals link new information to what they already know in order to make it meaningful and memorable.

3. The goal of the interface designer is to facilitate the process of developing an effective mental model of the learner in order to promote ease-of-learning and ease-of-use.

Cognitive styles, by embracing both perceptual and cognitive domains, provide a powerful framework for evaluating the effects of various design strategies on the learners' ability to develop an effective mental model for learning the content information of an E-Book. Cognitive style can be considered a contextual variable or construct because what the learner brings to the online learning task is as much a part of the context for the learning experience as are the more prominent features and learning objects of the E-Book itself. This is one of the key characteristics of the system.

Research findings suggest that a lack of ease-of-use and ease-of-learning for online materials may be caused by the discrepancy between the learner's current mental model dictated by his or her cognitive style, and the given operations of the scope of action and learning required by the software and design features of the E-book. Consequently, the present invention enables an E-book designer to cast both the interface and media in terms of the mental model of the user to insure successful learning.

A cognitive style profile is a picture of how a person, or user, searches for meaning. The learner is preferably administered an online self-report inventory of items to identify, or assess, his/her educational cognitive style. This results in a cognitive style map or profile that includes three interrelated sets of information: (1) theoretical and qualitative symbols (i.e., linguistic and experiential variables, (2) cultural determinants (i.e., modes of learning), and (3) modalities of inference (i.e., thinking strategies).

Responses to the items are weighted and the scores for each item are tallied and summed by the program's software. The cognitive style map (output) is a display showing the learner's major, minor, and negligible cognitive style elements.

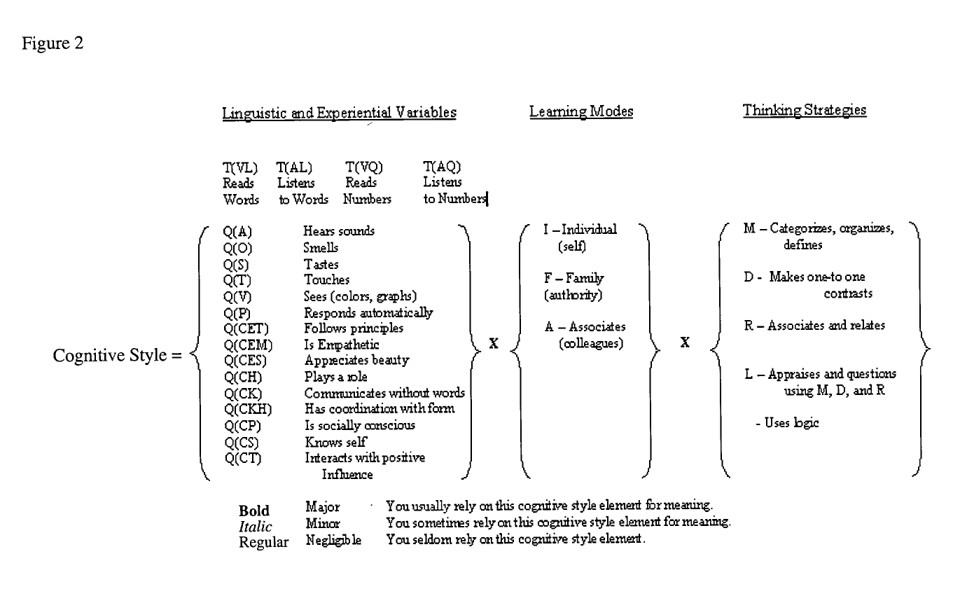

Referring now to FIG. 2, the linguistic variables that the individual may or may not rely on include, but are not limited to, reading words, listening to words, reading numbers, and listening to numbers. The experiential variables include, but are not limited to, hearing, smelling, tasting, touching, seeing (colors, graphs), responding automatically, following principles, being empathetic, appreciating beauty, playing a role, communicating without words, having coordination with form, being socially conscious, knowing self, and interacting with a positive influence. The cultural determinants a learner relies on include, but are not limited to, independence, authority, or peers. The thinking strategies a learner may possess include, but are not limited to, thinking in an organized way, appraising information, comparing and contrasting information, associating and relating information, and using inductive reasoning. The combination of these variables, which the learner usually relies on for meaning, sometimes relies on for meaning, and seldom relies on for meaning, is his or her cognitive style.

Because each learning task is somewhat different and requires different learning style strategies, the learner's cognitive style is mediated by the kind of learning task facing the learner. E-book features, including media used to deliver the feature (for example, a pronounce/define auditory option for verbal tasks) are assessed for their cognitive style (information-processing requirements) using the same cognitive style mapping process. The instructional designer would employ an empirical mapping of the cognitive style requirements of the learning task and media delivery component. The goal of the instructional designer would be to select E-book features and media that are robust and can accommodate a variety of cognitive style/learning style attributes.

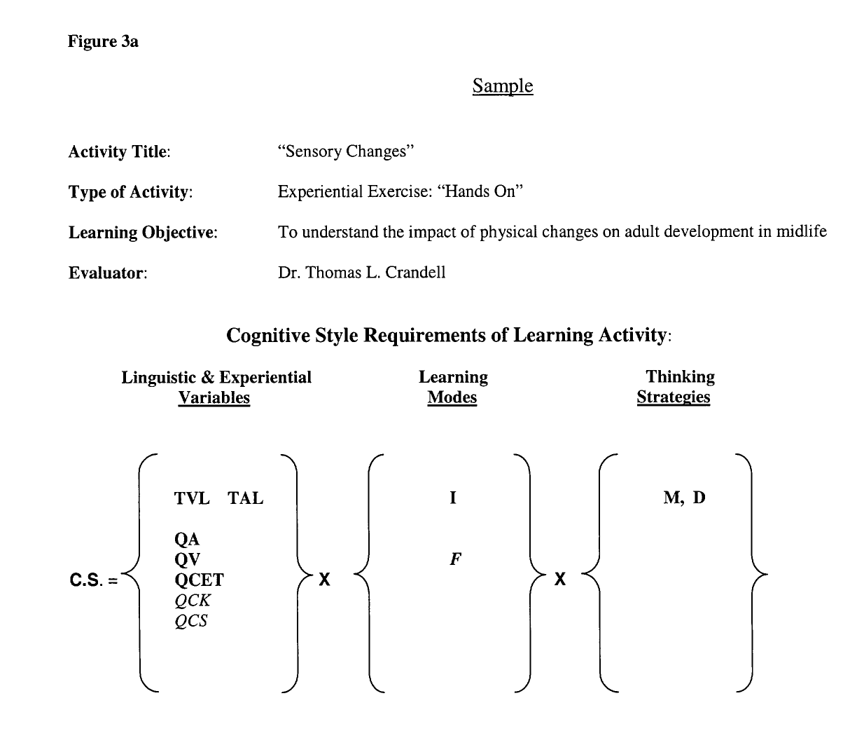

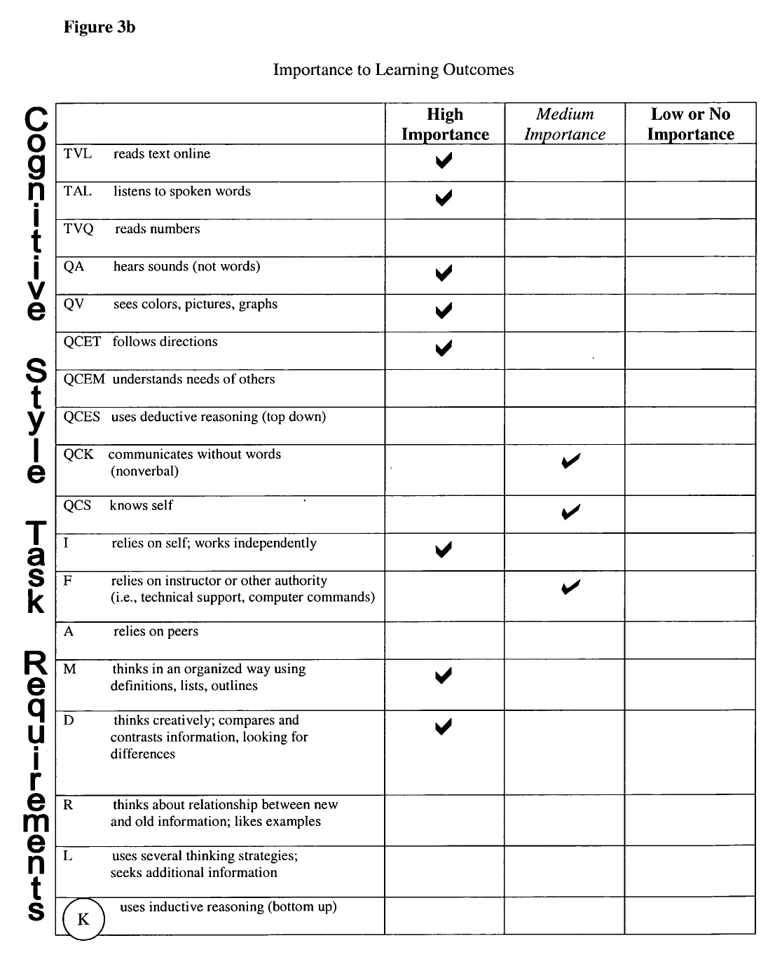

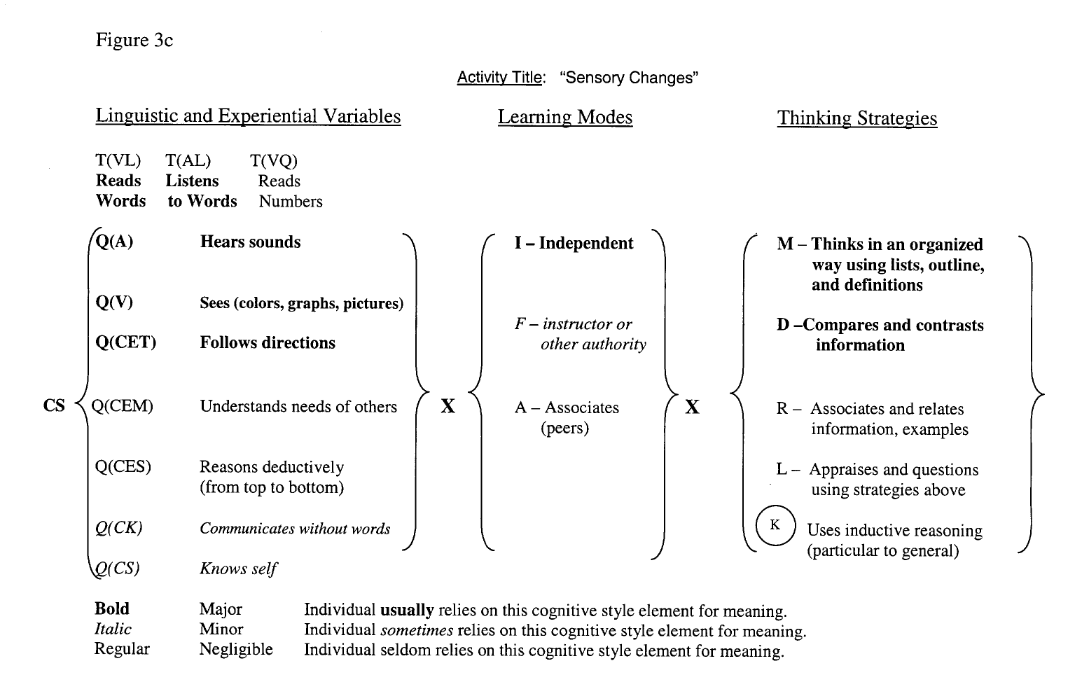

FIGS. 3a through 3c show a task and its cognitive style requirements. In this example, the activity is entitled “sensory changes”. It is a hands on, interactive activity, being used to understand the impact of physical changes on adult development in midlife. Reading words and listening to words are major linguistic variable requirements of this task. Hearing sounds, seeing colors, graphs, and pictures, and following directions are additional cognitive style elements that are required for this task. Communicating without words, and knowing oneself, are minor cognitive style elements to be relied on for this task. An independent learning mode is of high importance, while relying on an instructor is of medium importance. Thinking in an organized way, and comparing and contrasting information are thinking strategies of high importance for this task.

An individual who had a cognitive style that matched the task requirements of this activity would learn the topic best by doing this task. However, a learner with a divergent cognitive style may have more difficulty learning the material using this specific task. Consequently, the particular learner may either require an alternative learning task or learning object with requirements more closely matched to his own cognitive style, or alternatively may be taught to use cognitive coping strategies to alter his cognitive style and complete the task successfully.

The present invention also includes a prescriptive learning strategy database. For example, a learner who processes information most efficiently by hearing words, rather than seeing words, would use an auditory pronounce/define feature when confronted with a learning task that requires he/she read words. Additional coping and remedial learning strategies are available by accessing the prescriptive learning strategy database.

So, rather than working with fixed learning styles and finding different instructional tasks (media) that connect with different cognitive styles, the method of designing an E-book of the present invention allows designers to use the dynamic relationship between individual approaches to learning, the nature of the learning task, and the model of delivering the task to positively affect learning outcomes.

By presenting course content information within a framework of individual differences, one is able to create online features for an E-book that will greatly facilitate the process of learning for all learners. These features include a variety of instructional methods and techniques that (1) accommodate various cognitive learning styles and (2) establish a robust interface that is needed in order to develop a personalized multimedia instructional system for any E-book regardless of the discipline (e.g., psychology, biology, business, etc.).

A career center section is also useful, and utilizes cognitive style theory. Besides expanding the knowledge base of possible careers, this section could suggest particular careers based on a user's cognitive style.

Applying Cognitive Style Determinants to User-Interface Design

No one interface can serve all users well. A thoughtful approach to user interface design, including interfaces for online educational products, should consider simultaneously the constructive nature of comprehension, features of knowledge domains, media attributes, and individual differences in how users assimilate information and how they learn. Many user interfaces fail to engage the user due to underlying biases and assumptions built into the design that “all users are alike.” Designers may go to great pains to determine their user set and fail to realize that within that defined audience a myriad of individual differences in cognitive functioning are causing users to filter the same information in very different ways.

The question of which user interface is best should be rephrased as a series of subquestions, such as: Which interface works best for which user task? And for which user group? How does the user interface meet the information-processing requirements of the user set and its subsets?

The publishing industry views online multimedia systems as the panacea for customized learning. However, online multimedia systems will never be truly personalized and learner-centered until individual cognitive styles drive the design process.

Cognitive Styles: A New Approach to Planning Personalized User Interfaces

Certain groups of learners may need a different instructional design or user interface because of their own way of apprehending, transforming, and using information; that is, because of their unique “learning or cognitive style.” Cognitive style refers to individual differences in how learners think, problem solve, and comprehend information. Cognitive styles represent stable, perceptual traits that cut across the traditional boundaries of intelligence and personality.

What and how a learner learns and interacts with a system depends on the individual's currently activated field of knowledge. Learners link new information to what they already know in order to make it meaningful. To engage the learner, designers should incorporate user-logic attention features into the design of the interface. The key is knowing which features work best for which learners.

Cognitive styles, by embracing both perceptual and cognitive domains, provide an effective framework for evaluating the potential effects of various design strategies on the learner's ability and desire to master a learning task successfully. Designing with individual cognitive or learning styles in mind encompasses two important, measurable design points—ease of learning and ease of use. Research on cognitive styles now spans four decades. Cognitive style models offer a promising, creative, and fresh approach to planning personalized educational software.

Selection of a Model for Assessing Learners' Cognitive Style

Selection of an appropriate cognitive style model is central to the development of any E-Book that addresses the importance of cognitive characteristics of the learner. While several learning style models are being used in classroom instruction, most of these use a simplistic matching strategy and often are not based on empirical research.

One cognitive style model to diagnose individual styles in learning was originally developed by Dr. Joseph Hill in the early 1960's. The term “cognitive style,” as used by Hill refers to the way learners receive and process information to derive meaning. The present invention adapts the Hill model to be used as an online, diagnostic assessment for measuring individual preferences (strengths and weaknesses of learners) for processing and learning information in both online and offline learning environments.

The present invention teaches a method for using cognitive style for planning instructional software and exploits the dynamic relationship among individual differences in learning and the nature and features of the online learning task. An important feature of the methodology is the development of a database of prescriptive, or compensatory, learning style strategies. These strategies provide learners with an alternative learning strategy when they are mismatched to the cognitive requirements of the learning task. The database of compensatory learning strategies is derived from the research literature on teaching and learning and from experiences of teaching students in primary, secondary and higher education over the past 30 years.

Using Cognitive Style Determinants to Classify Learning Tasks

The traditional approaches to establishing guidelines for the selection and the use of media and techniques in user interface and instructional design represent across-the-board applications based on considerations of general properties of the media and broad-based levels of learning. All of these suffer from too much generality. In short, the traditional approaches, in their eagerness to examine the learner as a whole or group, often fail to examine and design to individual characteristics of the learners as human beings.

When stimuli in design formats are perceived, they are not acted upon in their raw form but are processed according to the user's cognitive style structure. These processed stimuli are then used to develop a solution to a problem the learner faces. Because the way the solutions are generated depends on the way the stimuli are transformed, cognitive styles, which dictate manners of transformation, affect the type of solution generated.

The success of the hypermedia and content presentations—whether graphical, textual or auditory—depends both on whether the information meets the learners' needs and the degree to which the representations fulfill the learners' information-processing requirements (i.e., cognitive style preference) and are appropriate to the learning task(s).

Building a bridge between the learner and the conceptual model of the E-Book and/or other educational software involves the following steps:

1. Take into account the learners' currently activated field of knowledge (i.e. cognitive style).

2. Cast the user-interface in terms of the cognitive style needs of different learners.

3. Anticipate how various learning features (activities, learning objects, etc.) in the E-Book will interact with the learners' cognitive style(s).

4. Provide for an alternative database of prescriptive learning strategies for learners who may be mismatched to the learning features/tasks of the E-Book.

Guidelines for the user-interface of an E-Book were drawn from various empirically based research studies on human-computer interaction, psycholinguistics, cognitive psychology, and reading research. Results were synthesized into a set of information usability guidelines.

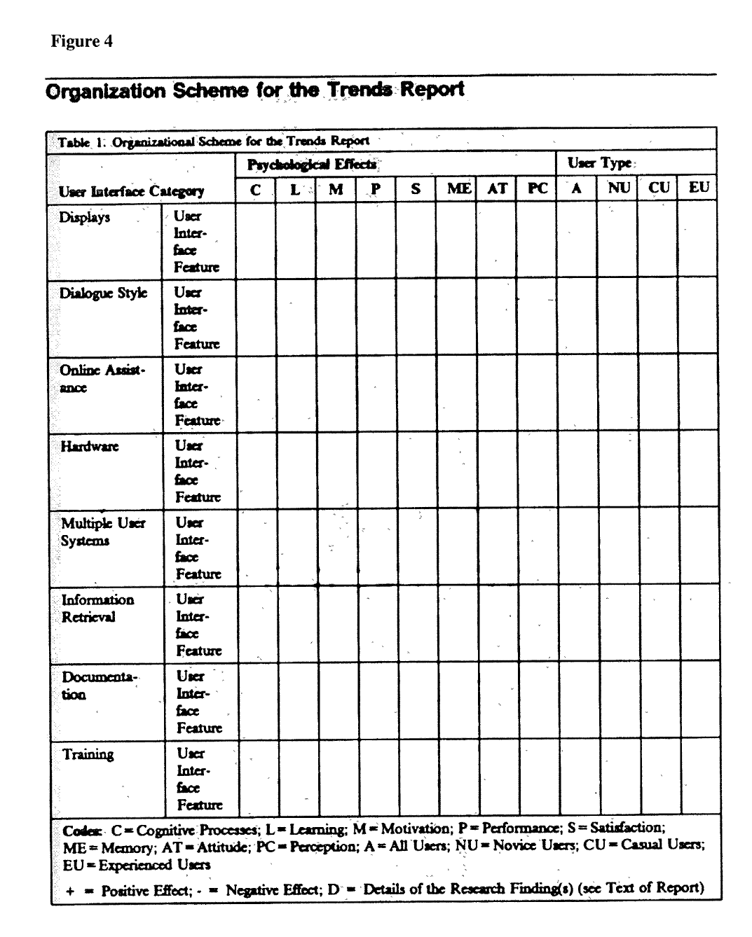

A sample organizational matrix used to report the research findings is shown in FIG. 4. The matrix is a way of identifying all topical areas that can be used to design effective user-interfaces for online information (e.g., computer screen design).

For example, under the category labeled “Displays”, color is a variable that impacts the quality and usability of an interface. Research on color shows that color has a positive effect on the user's ability to follow procedural directions but may have negative effects on the user's comprehension of the information. The designer should therefore use color when the online task requires that learners follow a set of directions for completing a task but use black type/font on white for comprehension tasks. For example, the design should not use a variety of colors to highlight text because the multiple use of color makes it difficult for the learner to identify relevant from irrelevant information and can confuse the learners.

As another example, right-justified text slows down the reading process because it creates irregular spacing between letters and words. This results in more eye fixations causing decreased reader comprehension. Whereas, ragged right-hand margins allow for uniform spacing within and between words, making reading faster and more comprehensible.

The matrix can be used as a desktop tool to assist the designer as he/she designs the user-interface of the E-book. Note also that the elements of the user-interface interact with the cognitive style attributes of the learner.

Post-hoc analysis of the cognitive style maps of current users/learners enables publishers to analyze and develop stylistic models of their user group(s). In turn, instructional designers will be able to anticipate and pre-design E-book features and media that are aligned with the preferred learning style(s) of their different user groups.

Correlating E-book Learning Elements (Features and Activities) with the Cognitive Characteristics of the Learner

In a hypermedia design context, the designer needs to address the correlation between the learner and the media. The results of the assessment of the learner's cognitive style prior to using the E-book serve as a gateway to the content material of the online book. When the learner begins a module of instruction, he/she is given the option of navigating the course module according to his/her preferred cognitive style.

In this way, the learner is given control of his/her own learning and is not restricted by the instructor's style of teaching or the limitations of the interface used to present the content information of the E-book.

Abstraction is often a key to the design strategy since media representations trigger different perceptions in different learners. A means to categorize these different perceptions is determined by an analysis of the cognitive style requirements of the learning task and the media elements used to present the task.

What has been missing from the learning styles' literatures for some time and is not being considered in the prior art design of E-Books or other educational software are the instructional implications of the cognitive style requirements of the learning task itself. A goal of the hypermedia designer is to assist learners in the construction of effective mental models, by including design features that accommodate different cognitive styles.

The success of the media and content presentations, whether graphical, textual, or auditory depends not only on whether the information meets the course objectives, but also the degree to which the media presentation fulfills the learners' information processing needs and the learning task requirements. Analysis of the cognitive requirements of the learning task produces a variety of learning task profiles. These learner profiles can be used by publishers of E-Books to assess the degree to which the E-book features match the learning style needs of its learner sets. From this data the profiles constructed by the media designer can be used to draw cognitive profiles, derive marketing strategies based on cognitive attributes and strategies, and provide new opportunities for content personalization in E-Books and other educational software.

Adaptive hypermedia tracks what features a user uses and which of those features work for him. By tracking these features, an adaptive system has the capability to suggest the features that work best for that particular user. For example, self-check questions inserted at key points in the text can be used to evaluate the features that the user chose and to see if those features successfully taught the user the material. After compiling data from sets of self-check questions, the hypermedia can suggest the features that work best for the user's learning style. This way, the E-book provides an ongoing assessment of the user's cognitive style and strengths for mastering the content material.

Prescriptive Learning Component

The framework for selecting media elements for a variety of learning style needs may not be entirely effective given the many different learning style elements by which people learn. Consequently, it is necessary to provide learners with alternative or remedial learning strategies.

The “prescriptive” learning component of the cognitive style product shows students how to alter or modify their cognitive styles when confronted with learning tasks that mismatch their preferred style of learning. One of the most effective techniques to help students learn how to function in a cognitive style mode different from their preferred style is to develop the student's learning repertoire beyond the scope of their preferred cognitive style.

An extensive list of specific coping strategies, derived from cognitive psychology, personal teaching experiences, and extensive educational research, form the product's “prescriptive” database and enable students to master content using alternative learning style strategies. In effect, students become more versatile learners. The prescriptive learning style database is important to the successful implementation of a personalized framework for e-learning. With this tool, learners are empowered to learn using their own unique learning style instead of being forced to learn according to the instructor's view of the material.

An important facet to an adaptive interface is the customization and personalization process involved in designing the interface using the cognitive style model of the user. Learners react differently to different mixes of sensory input; for example, auditory, visual, and textual elements. The visual layout of the screen and design of the media is an important facet and properly designed will result in a robust interface that is sensitive to different learning styles. The ability of the learner to control the media options and select remedial learning strategies from the prescriptive database puts the learner in control of the learning process.

The more electronic elements, such as linkages, branches, input/output elements, and navigational tools correlate with the cognitive style of the user, the higher the probability that meaningful learning will occur for all learners.

This online learning environment enables the learner to explore and learn the content material at his/her own pace and access media and support tailored to his/her individual cognitive style/learning needs.

### EXAMPLE

A typical application is a media selection based on the comparison between the content of the media presented and the learning style profile of a particular user. The process proposed here is supplantation. Supplantation is an explicit alteration of an instructional task such that it accommodates or supplants for a learner the information-processing requirements of the task that the learner is unable to perform on his or her own.

An E-book design feature such as linear text (i.e., strings of words on the screen) would be difficult for a learner to process who prefers a spatial-oriented approach to learning the content material. Concept maps are visual outlines, or graphical representations of textual concepts. Concept maps can be used as advanced learning aids for learners who prefer to see pictures rather than read words. An example of a concept map for a module on middle age is shown in FIG. 4.

Concept or spatial maps are preferably developed for each learning module of an E-book. Learners whose cognitive style preference is to see pictures have the option of viewing a concept map of the content material to be learned for a given module of instruction. Once previewed, the concept map serves as an advance organizer for the text. By visually scanning the concept map first, the learner is able to read the text in a more receptive and relaxed fashion because the text's concepts to be learned are also presented in graphical format thereby serving as a form of supplantation for the visual learner.

The learner's cognitive style map presented to the learner prior to using the E-book will have made it clear to the learner that he/she has a strength for processing concepts visually and would recommend that he/she always click on the icon for concept maps prior to reading the text-based information for a given module. The visual outline strategy is preferably a part of the prescriptive database and serves as a remedial strategy for all learners who prefer to learn using pictures over text. This approach develops a framework to help hypermedia designers of E-books address content personalization and customization.

Feedback

The present invention also preferably includes a feedback mechanism. For example, this feedback could be given to the individual learner, the instructor, the author of the E-book, or the E-book publisher.

Regarding the user, the E-book could offer feedback to the user based on the self-test he/she took to assess his/her cognitive style. The E-book may suggest, for example, that the user listen to the auditory component of pronounce/define of key terms, since this type of learning is matched to that user's cognitive style. If a learner is struggling with a particular module, the E-book may offer additional feedback regarding which features may be most helpful based on the user's cognitive style.

Feedback is also very useful for an instructor teaching a course using the E-book. He or she can identify which concepts students are having most difficulty learning and then suggest different E-book features and/or prescriptive learning strategies that match the cognitive style preferences of the learner(s).

The instructor gets feedback, both about individual students, and about the class as a whole. He or she can obtain a composite cognitive style map of the class, and identify the cognitive style preferences of the majority of the students in the class. The instructor can use these composite maps to tailor his or her teaching strategy to best suit the learning styles of the students in the class. This is a critical feature for all instructors of distance education courses.

The author and publisher also could receive feedback about the features of the E-book. For example, they could receive information about whether a particular feature, designed for students with one or more cognitive styles, was actually teaching that particular subset of students the material. If feedback showed that that feature was unsuccessful, the author and/or publisher could change it. Since the media is online, the feature could be immediately changed to another feature more in tune with the learners with the cognitive style(s) it is trying to reach.

Features for Prototype E-Book

The features of the E-book are pre-selected and designed to allow for as many different cognitive style attributes as possible. The prescriptive database helps learners who encounter cognitive mismatches to select alternative/remedial strategies for processing the same information in a less resistant manner. This optimizes learning outcomes for all learners regardless of their preferred style of learning, as different media attributes accommodate different cognitive styles.

The features selected for an E-Book are preferably chosen so that they enhance the conceptual model for an online book and match or compensate for various cognitive styles. All of these features give the E-Book the “feel” and “look” of a college classroom, the metaphor for the conceptual model of the E-Book. Features include, but are not limited to:

Valid, factual, and up-to-date information in the discipline of the book

Concept maps provide a spatial map for visual learners and serve as a high-level visual outline linking major and minor concepts hierarchically (mirrors the human memory system).

Guest speakers in motion/video format

Hyperlinks to quality web sites such as audio files, audio clips, animation, and career sites, to accommodate different learning styles and engage and motivate the learner to complete and understand the content material.

Hyperlinks to allow students to participate in national studies, for example studies at the National Institute of Health (NIH) or the Center for Disease Control (CDC). This participation potentially makes a student's learning more meaningful, as it creates a real world context to the material. It also stimulates discussion between students and teachers.

Pronounce/define feature accommodates learning key terms and hearing technical jargon in text—especially useful for auditory, learning disabled, or foreign-speaking learners.

Critical thinking questions serve as advance organizers to get students to think about what they already know and to reflect on their personal opinions before they begin reading the chapter.

Life-span scenarios tied to significant life events for psychology E-Books. These are especially engaging and effective in enhancing the learning needs of female learners using an online medium.

Discussion questions, at the end of smaller “chunks” of reading, serve as a review of what the student has learned, and serve as cognitive breaks in reading large amounts of text.

Self-check questions provide analysis, feedback, and corrective information, especially useful for the independent learner who wants to proceed at his/her own pace. For questions that are missed, the user can automatically be returned to the section where that material was covered.

Interactive activities clarify some of the more difficult concepts in the chapters, especially those that relate to abstract concepts. These are designed to put the learner into an active learning situation so they experience the concept. They especially match the learning style of hands-on, experiential learners.

Communication tools allow for discussion and feedback from professor to student, student to student, expert to student, and graduate student assistant and student. Students can collaborate on projects and enter discussions with peers—an especially significant social feature for female learners.

Text art, figures, charts, diagrams, animations, and tables illustrate concepts and accommodate students who are visual learners and require examples and applications.

A navigational tool tracks individual student progress through the modules, without being lost in hyperspace. An internal tracking system visually displays to the student what has been read (where he/she has been online) and how much more is to be completed in that module/chapter. This is an important feature for all learners.

E-Book Icons

Using this icon list, students quickly learn what action or feature each symbol represents. The shape of the icon is chosen to give the reader a quick visual signal of important information or an action to be performed (especially important for visual learners):

Text Item

Additional Information

Web Link

Interactive Exercise

Evaluation

Discussion Question

Critical Thinking Question

Video

Audio Enhancement

Concept Map

Additional Applications for Methodology

The conceptual framework for e-learning extends beyond individual E-Books. The conceptual framework can be applied to an entire array of online educational products, for K-12 through higher education, special education, assessment and educational testing, life-long learning, and corporate training markets. Using the methodology, educational publishers could expand their universe of consumers by utilizing the present invention in designing easy-to-use, personalized online learning products that cut across content boundaries and can be used in a number of markets, including:

Distance Education Programs Using the present invention, sterile online learning environments can be turned into dynamic and engaging experiences for learners of all ages instead of being created on the assumption that “one size fits all.”

Special Education Markets (students with special learning needs in inclusive classrooms, resource rooms, and college remediation programs, etc.). The present invention is also designed to be used as a value-free, individual education plan (IEP) for the primary and secondary school programs. This invention could aid in mainstreaming special education students into an inclusive classroom environment.

Online Home Study curricula for individual and charter school programs

Corporate Training Programs where instruction can be tailored to the learning style needs of the trainee and delivered in a personalized, online training system.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A personalized electronic work, comprising a plurality of features of a content of the electronic work, wherein the features are mapped to a plurality of cognitive styles.

2. The work of claim 1, further comprising feedback, wherein the feedback shows a user which features of the mapped content best match the cognitive style of the user.

3. The work of claim 1, wherein the work further comprises a prescriptive database, wherein when the mapped content does not match the cognitive style of a user well, the prescriptive database provides the user with at least one strategy to overcome the mismatch.

4. The work of claim 1, further comprising a feedback mechanism for providing feedback to at least one individual selected from the group consisting of:
a) a teacher using the electronic work in association with a course he or she is teaching;
b) a publisher of the electronic work; and
c) an author of the electronic work.

5. The work of claim 1, further comprising a personal interaction between a user and at least one other individual, such that the personal interaction facilitates a comprehension of the material in the electronic work by the user.

6. The work of claim 5, wherein the other individual is selected from the group consisting of:
a) a graduate student in a field of the electronic work;
b) an instructor teaching the course;
c) an expert in the field of the electronic work; and
d) other users of the electronic work.

7. The work of claim 1, further comprising a composite map of the cognitive styles of a plurality of users.

8. The work of claim 7, wherein the plurality of users comprise a sampling of students intended to use the electronic work.

9. The work of claim 1, further comprising an individual map of the cognitive style of an individual user.

10. The work of claim 1, wherein the features of the electronic work are selected from the group consisting of:
a) factual information in a discipline of the electronic work;
b) a plurality of concept maps;
c) a plurality of guest speakers in a motion or video format;
d) a plurality of hyperlinks to web sites related to a discipline of the electronic work;
e) a pronounce/define feature, wherein this feature accommodates learning key terms and hearing technical terms in text;
f) a plurality of critical thinking questions before each chapter or subchapter of the electronic work;
g) a plurality of life-span scenarios for electronic works in a psychological discipline;
h) a plurality of discussion questions at the end of each chapter or subchapter of the electronic work;
i) a plurality of self-check questions;
j) a plurality of high-level, interactive activities;
k) a plurality of communication tools to facilitate electronic discussion and feedback from professor to student and student to student;
l) a plurality of text art;
m) a plurality of figures;
n) a plurality of charts;
o) a plurality of diagrams;
p) a plurality of animations;
q) a plurality of tables; and
r) a navigational tool to track a learner's progress through the electronic work.

11. The work of claim 1, further comprising a cognitive style assessment tool for a user of the electronic work.

12. The work of claim 1, further comprising a cognitive style assessment tool for the features of the electronic work.

13. A method of designing a personalized electronic work, comprising the steps of:
a) mapping a plurality of features of the content of the electronic work to a plurality of cognitive styles;
b) assessing a cognitive style for a user;
c) evaluating mapped content relative to at least one attribute of the cognitive style of the user; and
d) providing feedback to the user based on step (c).

14. The method of claim 13, wherein the feedback shows the user which features of the mapped content best match the cognitive style of the user.

15. The method of claim 13, wherein when the mapped content does not match the cognitive style of the user well, the method further comprises the step of providing the user with at least one strategy to overcome the mismatch.

16. The method of claim 13, further comprising the step of providing feedback to at least one individual selected from the group consisting of:
a) a teacher using the electronic work in association with a course he or she is teaching;
b) a publisher of the electronic work; and
c) an author of the electronic work.

17. The method of claim 13, further comprising the step of providing a personal interaction between the user and at least one other individual, such that the personal interaction facilitates a comprehension of the material in the electronic work by the user.

18. The method of claim 17, wherein the other individual is selected from the group consisting of:
a) a graduate student in a field of the electronic work;
b) an instructor teaching the course;
c) an expert in the field of the electronic work; and
d) other users of the electronic work.

19. The method of claim 13, further comprising the step of providing a composite map of the cognitive styles of a plurality of users.

20. The method of claim 19, wherein the plurality of users comprise a sampling of students intended to use the electronic work.

21. The method of claim 13, further comprising the step of providing an individual map of the cognitive style of an individual user.

22. The method of claim 13, wherein the features of the electronic work are selected from the group consisting of:
a) factual information in a discipline of the electronic work;
b) a plurality of concept maps;
c) a plurality of guest speakers in a motion or video format;
d) a plurality of hyperlinks to web sites related to a discipline of the electronic work;
e) a pronounce/define feature, wherein this feature accommodates learning key terms and hearing technical terms in text;
f) a plurality of critical thinking questions before each chapter or subchapter of the electronic work;
g) a plurality of life-span scenarios for electronic works in a psychological discipline;
h) a plurality of discussion questions at the end of each chapter or subchapter of the electronic work;
i) a plurality of self-check questions;
j) a plurality of high-level, interactive activities;
k) a plurality of communication tools to facilitate electronic discussion and feedback from professor to student and student to student;
l) a plurality of text art;
m) a plurality of figures;
n) a plurality of charts;
o) a plurality of diagrams;
p) a plurality of animations;
q) a plurality of tables; and
r) a navigational tool to track a learner's progress through the electronic work.

23. A method of designing a personalized electronic work, comprising the steps of:
a) selecting a plurality of users which comprise a sampling of students intended to use the electronic work;
b) providing a composite map of the cognitive styles of the plurality of users;
c) selecting a plurality of features for the work that are best suited to the most common cognitive styles of the students reading the work; and
d) mapping the features of the content of the electronic work to a plurality of cognitive styles.
